(19) United States
(12) Patent Application Publication
(10) Pub. No.: US 2018/0046776 A1
(43) Pub. Date: Feb. 15, 2018

(54) MEDICINE REMINDER AND INDENTIFICATION TECHNOLOGY

(71) Applicant: Paul Robert Chalifoux, Naples, FL (US)

(72) Inventor: Paul Robert Chalifoux, Naples, FL (US)

(21) Appl. No.: 15/236,399

(22) Filed: Aug. 13, 2016

(51) Int. Cl. G06F 19/00; G06T 7/00

(52) U.S. Cl. CPC G06F 19/3456; G06T 7/0012; G06F 19/322; G06T 2207/10004

(57) ABSTRACT

A method of capturing images of medications and managing a schedule for a user to take the medications is disclosed. The method comprises capturing, by an imager, images of medication prescribed for a user. The image comprises pill size, shape, color, and texture. The method comprises defining, by a micro-computer chip, a schedule for the user to consume the medication prescribed. The method comprises alerting, by the micro-computer chip, the user to consume the medication based on the schedule. The method comprises capturing, by the imager, a new image of the medication when the user is alerted. The method comprises comparing, by the micro-computer chip, the new image of the medication with the images of the medication prescribed for the user. The method comprises turning off, by the micro-computer chip, the alert when the new image of the medication matches with the images of the medication prescribed for the user and the schedule defined.

### BACKGROUND

### Field of the Invention

The present invention refers to a method of medication adherence, compliance and oversight. It is used by healthcare institutions, healthcare professionals, families and individuals. Technology identifies medications, creates a database of compliance, and allows access to qualified personnel based on HIPPA laws and regulations. Non-compliance with prescribed medication regimes produces alarms sent to overseers. A new method of pill recognition is utilized. Pills are identified to confirm medication type, dosage, time, number of days and that a person took or was given the proper medications.

### Description of Concurrent Art

Present technology reminds a person to take medication on smart phones, watches, pill boxes, alarms and the like. A person must shutoff a reminder manually. A person presses an off button to stop the reminder. It is assumed a person will take their medications after shutting off an alarm however that is not always the case. A person often simply shuts off an alarm to stop the annoyance of hearing an alarm and continues what they are doing. In addition, patients take the wrong medication. Often a person takes so many medications that they get confused and take the wrong one or the wrong amount of medication.

It would be advantageous to have a system that helps identify a medication without having a large database of medications and provides a method to assure medication, as well as the proper medication, is taken.

In healthcare facilities, computer programs tell healthcare personnel when to administer medications. There is no verification that 1. The information entered into the computer system is correct and 2. The medication was actually given and given correctly to a patient. Compliance is further important to produce valid medication effectiveness studies.

### SUMMARY OF THE INVENTION

The instant apparatus and system, as illustrated herein, is clearly not anticipated, rendered obvious, or even present in any of the prior art mechanisms, either alone or in any combination thereof. A versatile system, method and series of apparatuses are revealed for creating and utilizing medication identification technology to assure patient compliance to take medications or be given medications correctly. Oversight alarm systems controlled by medication identification are used. Medication identification is accomplished by bar code or medication imaging. Bar code imaging of pill or liquid medication packing provides one means of identification. It is understood but not always mentioned in the following explanations, that this option is available.

In the preferred embodiment, a wearable technology reminds a person when it is time to take medications. A reminder continues periodically until medication is imaged. It is assumed a person will take a medication after spending time and effort to perform imaging. Several versions are used including imaging produced by a separate scanner, image produced as part of the wearable device or cell phone or a computer app using the onboard camera. Computer programs compare an image of a pill produced in an imager to a personalized database of pills to identify a pill. The number of pills is also identified. Pill identification assures the proper medication is taken. Instead of relying of a large database of over 30,000 pills, a personalized database provides comparison to only a few pills making identification significantly easier. Imaging is accomplished through scanning or camera technology to produce an image. Imaging is accomplished on one side or both sides of a medication. One camera or multiple cameras provide multiple views of medications in advanced versions.

People often cannot afford complicated reminders. In its simplest form, the reminder of this invention sounds an alarm and is shut off by taking a photograph of the required medications. No image or record is kept of the medications. The system is a simple reminder with self-oversight to improve a person's self-discipline.

Alarm systems are incorporated into a remote device or consolidated into one central imaging and control center. In the preferred embodiment, the alarm/reminder system is wearable. A wearable reminder in the form of a watch, bracelet, necklace, ear piece, incorporated into clothing, a cell phone or other common wearable method is used. Wearable technology includes a method of communication with a control unit, computer or scanner. Common methods such as Bluetooth, radio, hard wire, wireless network, or the like are used for communication between devices.

Wearable technology may simply provide an alarm or more complex reminders including a digital display providing written directions, voice directions and voice recognition. Wearable technology may include a camera to photograph pills or a scanner to produce images though this is not required or preferred. Wearable technology may be completely self-contained and not require auxiliary devices.

Scanner or camera technology, referred to as imaging technology, is combined with image recognition to identify pills. An image is compared to a database of pill images. The database of pill images is small. It utilizes only the information of the prescribed pills for that person. Over the counter medications such as baby aspirin, vitamins and the like can be included. In an alternative procedure, when a prescription is received, a bar code is scanned by a wearable device or a control center to enter information into a database specific for that patient and that drug. Image recognition identifies pill size, shape, surface texture, surface features, color, differential size of features, and pill identification code.

Pill information and prescription directions are entered at a pharmacy, at home by a patient or caregiver, by a doctor or nurse and can be preprogrammed for common drugs. Alternatively, a pill from the prescription bottle is scanned by the patient to create the image database. Information such as dose, how many pills, how often pills are taken and for how many days or total doses entered are included. Preprogrammed information or custom information is entered through voice recognition, through typed information, bar code or other scanned information and the like. Because the database is limited to the pills a patient requires, large amounts of information is not required. A database of the user medications can be stored on the device. It is not necessary to use a cloud based database of large volume. Alternatively, a central control unit enters all information. For example, a doctor's office writes a prescription to go to a pharmacy electronically. The electronic transfer to the pharmacy simultaneously enters information into a central control for the reminder.

The reminder system is configured to perform appropriately for different situations. Nursing homes, assisted living facilities, hospitals, memory care facilities use it as a quality control method to be sure each patient receives the proper medication. A patient wears a device to monitor their drugs. Drugs are given to them in a hospital, medical facilities or by caregivers. Alternatively, a central unit is carried by medication dispensing personnel. Personnel use one device with a central database for all patients. Personnel review patient's medication requirements as presented by the system. Pills are placed on a photograph pad and imaged. The system records the image after identifying pills. Pill identification is accomplished using that patient's custom database. The next patient file is recovered and process is repeated for the next patient.

Elderly, disabled, sick or mentally handicapped use the reminder system at home and require various options to enter information. A person picks up medication at a pharmacy. A pharmacist enters pill information into the wearable device based on pill and prescription requirements. A pharmacist, pharmacy assistant or even the patient scans a bar code to have information entered into the wearable device. The person brings the medication home and places the bottle on a shelf. Alternatively, medications are placed into dispensing containers or organizers and used in conjunction with the reminder.

In the preferred embodiment, a wearable device produces a reminder for a ten second duration. A reminder reoccurs every five minutes until pills are scanned. The reminder delays for one hour after four reminders. After four reminders, a message of non-compliance is sent to a designated overseer. A person gets pills from the bottle and places them in an imager. The imager creates images of the pills and through image recognition, identifies that they are the correct and correct number of pills. An advanced imager produces images on both or just one side of a pill. Producing an image may be as simple as a camera generated photograph that is compared to a database of photographs showing pill type, size, shape, color, identifying codes and texture.

In the preferred embodiment, wearable technology includes communication technology such as Bluetooth to communicate between devices, provide voice recognition, compute pill recognition and control a display screen; a battery that may be rechargeable, an alarm, a display screen, a microphone, a speaker and like components similar to high tech watches. Communication with a computer, cell phone, iwatch and the like limits the need for some components. Synchronizing technology further adds to its usefulness and oversight. For example, information is conveyed to an application database. Authorized personnel such as a doctor or relative follows database information to oversee compliance. People providing oversight are sent a notice when compliance is not followed.

Because elderly often have limited finances, a simple wearable device is used. A simple alarm and communication module with an existing computer or a special control center using cell phone like communication is used. A simple camera takes an image of pills placed on a counter top or sheet of paper.

People not taking prescribed medications or taking the wrong one are a major concern and cost in the healthcare industry. Patients are not given proper medications in healthcare facilities. The reliance on human decisions and resulting human error is a major problem.

A review of present technology shows there are special containers that sound alarms or organize pills but it is too easy for a person to simply shut off the alarm so it does not disturb them. They then forget to take the medications. Apps on phones and watches provide reminders but do not provide a method of compliance with oversight that the medication is actually taken. Scanning technology is available to identify pills. It relies on images of identification codes to compare pills to a database of all pills. There are over 30,000 medications so comparison is difficult if a complete database is used. Pill identification does not work well, requires large databases of pills and results are too slow to be used by patients. Present scanner technology is being proposed for hospital use but at great cost and large equipment requirements.

The proposed system requires imaging of a pill by a patient to shut off a reminder. A more advanced system images and identifies pill type and number. It is assumed a patient will take pills if they spend time to image them. The database required to identify medication is simply based the number pills prescribed for that person so results are quick which aids in compliance. In addition, the limited database of medication improves time and accuracy to identify medications specific for a patient. When a database has over 30,000 pills, errors occur as too many pills look similar. For liquid medications, a bar code on the bottle or packaging is imaged.

### Comprehensive Medicine Adherence Review

Medicine adherence is a complex issue. It affects millions of people around the world. Present systems provide little oversight assuring compliance. The present invention provides a comprehensive system of reminder, quality control and oversight including patient, physician, medical personnel, pharmacy, caregivers, family, hospitals, nursing home, assisted living, and memory care facilities. The system will be called The Invention.

### The Invention Systems

The Invention provides medication adherence through reminder and medication identification. Medication identification includes proper:
1. medication type
2. dosage
3. time
4. number of days
5. confirmation that a patient was given or took the medication

### How it Works:

A reminder alerts a person to take medication followed by pill recognition to assure compliance. An alarm goes off at regular intervals until medication is identified using recognition technology. A scanner/camera images medications and recognition software identifies it referencing to a database of medications.

### Novelty:

1. An alarm continues until pill identification occurs. It is assumed a person will take medication immediately after identification. If the alarm goes off four times without medication recognition, a family member or caregiver is notified.
2. A novel system of pill identification is used. The federated database of drugs, medicines etc. from NDC-US will be utilized as a secondary source however, is not required for The Invention technology. Pill identification uses imaging technology to analyze pill size, color, type, shape and texture. A database of pills is limited to those pills a patient is taking for comparison. If a patient is taking 7 pills, the pills will be imaged to form a custom database. If a pill does not match the database, a warning system sounds.
3. A central cloud database allows oversight of medication compliance by multiple entities. Events occurring with The Invention are entered into a database noting time, medications recognized and events of non-compliance. A doctor's office, university study, family members or healthcare works can be granted access to the database to observe levels of adherence. Alarm Systems:

Alarm systems include watches, pagers, smart phones and the like. Devices are synched to computer systems that send information to caregivers or family members providing oversight compliance. Alarm systems are based on visual instruction, sound alarm and physical vibration.

### Image Systems: Scanner/Camera

A single unit may provide an alarm and imaging capabilities. For example, a cell phone sounds an alarm. The person gets their medications and takes a photograph of the pills with the cell phone camera or identifies a bottle bar code. A cell phone app identifies the pill by comparing it the personalized database of pills and the number of pills. When a proper match is identified, the alarm shuts off. If a person has taken the time to get the pills and identify them, they will consume them at that point.

### Defining Usage

### Patient

People taking medications are categorized as occasional, routine and complex.

Occasional medicine patients are prescribed a drug for a short term. For example, when treating an infection, an antibiotic is prescribed QID for 10 days. A busy schedule often leads to a person forgetting to take medications. The occasional user requires a quick reminder and verification. A cell phone APP is an ideal solution. Verification may be simply photographing a pill without the need for identification will be an option. A secondary option will be a reminder with no verification.

Routine medication patients are prescribed drugs for a chronic condition. A person may be taking one or two medications. For example, a person may require a beta blocker for high blood pressure and an anti-anxiety medication. Reminder and verification is accomplished with a cell phone APP or reminder watch and scanner.

Complex medicine patient are prescribed many drugs for several conditions. Drug combinations may require taking drugs QID, TID, BID or QD. It often becomes overwhelming for a person to remember which medications to take and when. Secondary factors such as memory loss or depression further complicate compliance. For example, a client may be taking high blood pressure, anti-anxiety, diabetes, reflux and antibiotic medications.

For complex medicine patients, a cell phone or watch reminder system provides critical oversight. The Invention provides a visual, vibration and sound reminder. Visual instruction includes directions for a patient including which pills and how many to take. For non-cell phone users and institutions, verification that a patient receives medication is provided by placing medications into a scanner box. A camera system in the scanner box creates an image of all the medications. Software identifies the pill type and number. Upon verification, the alarm system shuts off and a person is instructed to take the medications. The scanner identifies pill removal from the box and sends verification information to a central cloud database. Optionally, information is forwarded by message text, email or phone to caregivers or family member.

Reminders occur every five minutes, last ten seconds and occur four times followed by an hour delay. If verification does not occur after the four reminders, a message, email or phone call is initiated to a caregiver or family member. Failure to shut off the alarm system alerts support personnel that a medical event, fall or other problem may have occurred to cause the delay in pill taking. Situational events such as going out to eat or other functions will be addressed with a series of delay buttons possibly controlled by a caregiver only.

### Caregiver

A caregiver provides oversight for a patient. The caregiver role can include:
1. Confirming proper medications are available
2. Entering information into a computer/reminder system.
3. Reviewing a database history of medicine compliance.
4. Receiving compliance or non-compliance information at time of a medicine reminder
5. Coordinating physician, facility and organization roles

### Family

Family members provide similar services as a hired caregiver including:
1. Confirming proper medications are available
2. Entering information into a computer/reminder system.
3. Reviewing a database history of medicine compliance.
4. Receiving compliance or non-compliance information at time of a medicine reminder
5. Coordinating physician, facility and organization roles

### Physician

A physician and physician office prescribes medications and overseas compliance. Compliance oversight may be limited to monthly, quarterly or yearly review of database information. Compliance oversight may be further augmented by database warnings of non-compliance sent to a medical office. For example, if the database identifies three non-compliance incidences in a week, a physician's office is notified. Patient compliance is reinforced with a phone call from office staff.

Patients with critical dependence on medications can be closely monitored. For example, a bipolar individual who becomes violent when off their medications is closely monitored for non-compliance.

In the future, a database of all prescriptions written and filled at pharmacies is achievable. Database monitoring will further aid in catching people scamming the system to obtain drugs. A national database of prescriptions will help stop repeat offenders at multiple offices.

A database of medicine compliance will further verify all medications a patient is taking. The role of multiple physicians prescribing medications often leads to drug interactions. A database of medications confirms all medications prescribed for a patient.

A database of medication compliance further identifies patients taking advantage of the healthcare system to obtain drugs for illicit use or drug habits.

### Pharmacy

A pharmacy coordinates information entered into a reminder system. A pharmacist reviews medications entered into a database to confirm no drug interactions, reinforce the importance of compliance and verify proper amounts of medication are maintained onsite. The database is used to provide automatic refills when appropriate.

A simple bar code system is used to enter information into the The Invention system. A quick bar code scan transfers information available in a pharmacy computer system to the reminder system.

### Medical Institutions

Hospital, nursing home, assisted living, memory care and metal health facilities are reminded to administer medication and verification that proper medication type, dosage and frequency is provided. The system provides this service through a cell phone APP or through a computer system. Healthcare providers are instructed which medications are to be given. An alarm sounds when medications have already been given medication and it is being repeated.

### Defining Components

Three approaches will maximize usage based on the requirements state for occasional, routine and complex users.

1. APP. An APP is designed to work on cell phones. The APP for android and apple cell phones will provide a visual, vibration and sound reminder when it is time to take medications. Reminders will occur very five minutes. Once four reminders have occurred, the next set of reminders will occur one hour later. Four different modes will be provided for a user including:
Standard Mode: Alarm goes off every five minutes until proper medications are scanned.
a. The screen provides pictures of the pills and instructions on how many of each to take.
b. Alarm is programmed around sleep patterns
Active Mode: Alarm goes off every five minutes until proper medications are scanned.

The screen provides pictures of the pills and instructions on how many of each to take.

Button to delay alarm for an hour (for example when going out to eat with friends

Work Mode: Alarm goes off every five minutes until proper medications are scanned

a. The screen provides pictures of the pills and instructions on how many of each to take.

b. Button to delay alarm for an hour (for example, when going out to eat with clients)

c. Button to delay for set time (time delayed so alarm does not go off during meetings)

Non-compliance Mode: This mode is for clients who strictly want a reminder. The screen provides pictures of the pills and instructions on how many of each to take. An alarm goes off until a person shuts it off with a button. Person uses APP as compliance for following other family member.
Non-compliance Mode is an important branding as these people will be buying systems in future to monitor parents or grandparents. A good experience at this level allows for trust when future purchases for themselves or family members are required.

The APP is used to access records and assure compliance of family members. Alerts sound when a family member using the APP on a separate cell phone or the watch scanner system does not take their medication.

2. APP and SCANNER. Many people will have difficulty capturing an adequate image with a cell phone camera. For these clients, a separate scanner is provided. The scanner is a box that pills are placed in. A grid inscribed on the bottom of the box is a reference of size comparison. A camera system on the top of the box captures an image of the pills. The images are analyzed and compared to the prescribed pills.

### 3. Watch Reminder and Camera/Scanner

### Watch Reminder

The Invention will create a watch based medication reminder. The reminder will utilize three forms of reminder including: vibration, sound and visual screen display.
The Watch Reminder will be prototyped by Peter Sosso a mechanical engineer at Fork, LLC

### Camera/Scanner

A camera based system will supply an image for software to recognize. A separate “box” will allow placement of pills. When the cover is closed, an image is produced and pill recognition occurs. Recognition of pill type and number of pills will occur. Recognition of the cover opening and pills being removed will complete the cycle to shutoff the watched based alarm. It is assumed and will be further studied, that a person will take the pills upon removal from the scanner.
The camera system will be prototyped and engineered by OWL ENGINEERING. Owl Engineering consists of former Polaroid employees who are experts in image capturing.

### 4. Cloud Database

A cloud secure encrypted database will store information to be reviewed by healthcare personnel, care givers or family members. Compliance will be monitored by physicians to judge effectiveness of treatment based on medicine adherence.
An options feature will be caregiver or family member notification if a person does not take medication after four reminders. It will be assumed the person either forgot to take the medication or something has compromised their ability to take medication such as a fall or medical event.
The IT company will use “access to federated database of drugs, medicines etc. from NDC-US as we integrate a lot of drug interaction in our AK Systems projects” when required. Pill identification will use patent pending technology to assure matching. It will be using recognition software from companies with “extensive experience with similar Photo Matching functionality. We have extensively used OpenCV and other custom algorithms for the same”. The patent approach assures proper pill recognition.

### 5. The APP

The APP is designed for two classes of users including:
1. A person who wants to be reminded but does not require oversight. For example, a person with a busy schedule who is likely to forget to take medications
2. A person who requires oversight. For example, an elderly person who would shut off an alarm and then forget to take the pills or would be prone toward taking the wrong pills.
   An example of the app design may include:

### Pages

Home Page
Profile Page
Medicine Cabinet
Medicine Prescribed and Taken History
Logins: separate for caregiver

### Features:

1. Login Sequence

Login—Create PIN Screen

Login—PIN Login

Login—Reset Password

Login—Reset PIN

Login—sign in

Login—Sign Up

Touch Fingerprint Identification
2. Home Screen

Profile

Prescription

Digital Medicine Cabinet

Daily pill box

Share

The setup is so a caregiver/doctor can only review information on patient compliance. The information is obtained either through separate login or information sent periodically. Alarm systems a set up for non-compliance.
3. Medicine Photo Capture Process
   Multiple pills are identified by size, shape, type, color, surface texture, identifying markings (not required unless a pill cannot be identified using other parameters). To aid in identification images may be taken on a pre sized object, a marked grid or at a fixed distance.
4 Medicine Details Capture Process
   a. pre captured images are used.
   b. a custom database is used (person produces an image from their pills.
   c. Pills are identified for type, size/dosage, number.
5. Set Reminder/Alerts Process

Two options are provided
a. option one: Alarm goes off until shutoff by touching the screen
b. option two: Alarm goes off until shutoff by image and pill verification
6. Digital Med Cabinet

Display Pill info from Pills Database

Display details with photo and Pill info from Database

Search Functionality
7. Daily Pill Box Screen Final with status skip-taken
8. Perform CRUD functionalities with the database
9. Maintain a database of daily pill taking. History based on alarm and confirmed shutoff.
10. Alarm will be customized by the user to include visual display, sound, vibration.
11. Display will show alarm to take pills followed by which pills and how many to take when screen is touched.
   Identify pills—a page to identify pills from an image by size, color, type (ie pill, capsule) and shape.
   A camera will take a photograph of a pill or multiple pills to be compared to a database for identification.
   Personalize reminder ie no reminder when sleeping from 9:00 PM to 7:00 AM. Shutoff for special occasions such as out to lunch.

Yearly subscription ie account payment must be verified yearly for app to work.

Advertising on the app for revenue if not subscription. The foregoing has outlined the more pertinent and important features of the present invention in order that the detailed description of the invention that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

There has thus been outlined, rather broadly, the more important features of the versatile wearable medicine reminder and scan technology system and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

The advantages of the present apparatus will be apparent from the following detailed description of exemplary embodiments thereof, which description should be considered in conjunction with the accompanying drawings, in which: Having thus described the system in general terms, reference will now be made to the accompanying drawings, which are not necessarily drawn to scale, and wherein:

FIG. 1 Illustrates a front view of a remote reminder and a side cross section view of a pill imager.

FIG. 2 Illustrates a top view and side cross section view of a combined reminder, pill imager and control center.

FIG. 3 Illustrates a top view of a remote reminder station and a side cross section view of a pill scanner.

FIG. 4 Illustrates an isometric view of a phone with an app.

FIG. 5 Illustrates a top view of pill pads for imaging.

FIG. 6 Illustrates a side view of an imager with a cell phone attached.

### DETAILED DESCRIPTION OF THE PREFERRED EMBODIMENTS

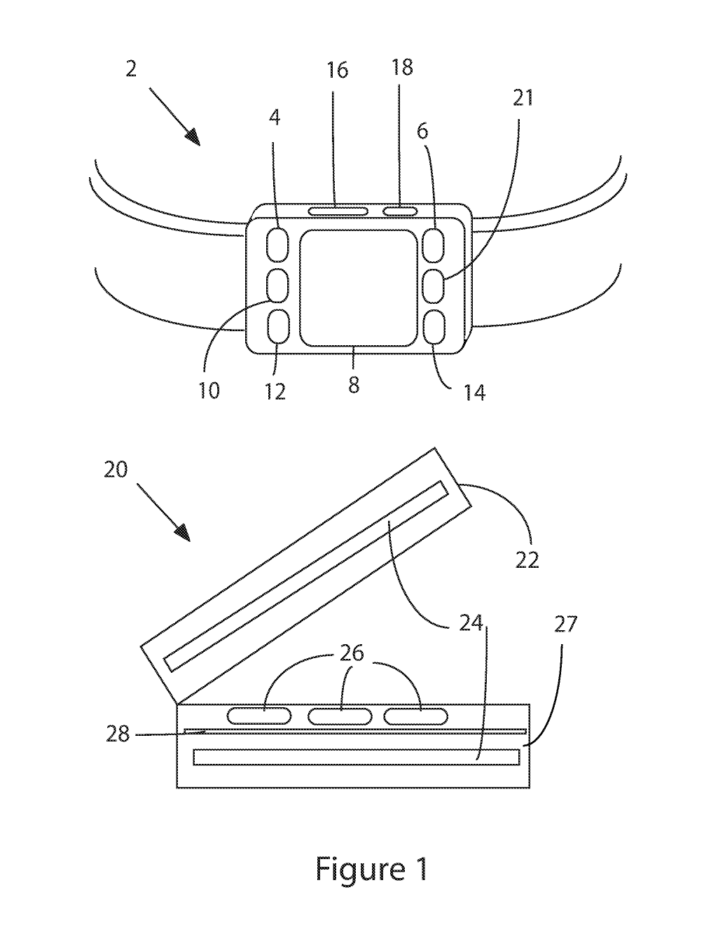

Referring to FIG. 1, a wearable medication reminder 2 includes microphone 4, speaker 6, on off switch 10, digital display 8, Bluetooth connection 14, micro computer chip 16, battery 18, warning light 12, and a band to secure it to a wrist. Imager 20 is a medication imaging technology.

Scanner 20 shown in cross section side view has cover 22 and base 27. Base 27 has glass plate 28 that pills 26 are placed on. When cover 22 closes onto base 27, scanners 24 creates an image of the top and bottom of pills 26. Pills are compared to a limited database created especially for a patient to identify the medication, how many pills and the dosage being used.

An alternative technique, a pill image is produce of only one side. A glass plate is not required to obtain an image from below the imager base. A single or multiple cameras are used.

Imager 20 may include scanner technology, a single camera, multiple cameras, top and bottom cameras or combinations of these. An image produced by imager 20 is compared using computer technology to a limited database of pill images to identify medications. Image recognition is limited by picture quality, orientation, limited to one side of a medication and user error. Scanner 20 is the preferred embodiment to provide a high quality and repeatable image.

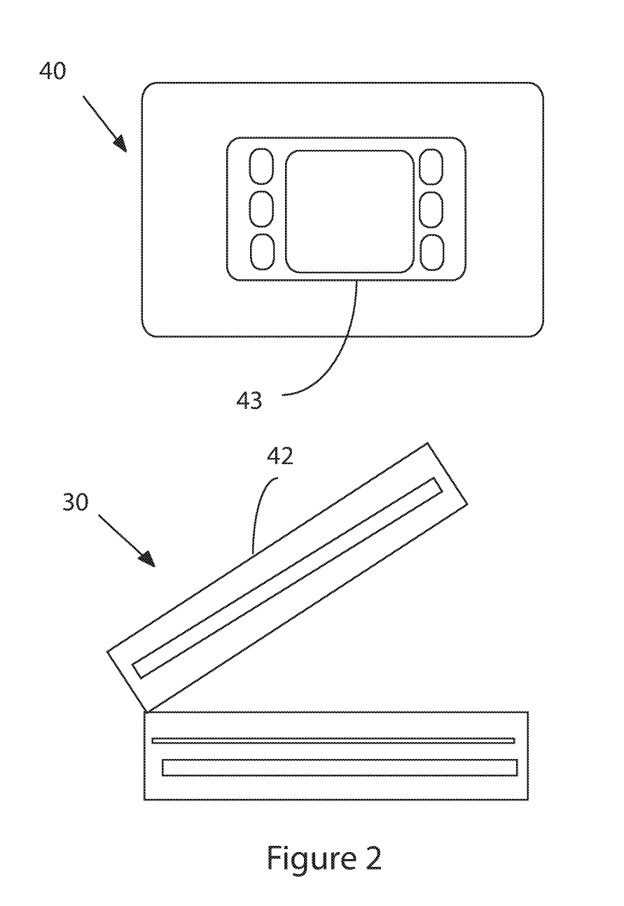

Referring to FIG. 2, combined alert system, scanner and control center are included in system 30. 40 is a top view of system 30. System 30 includes all the features of the FIG. 1 system includes a microphone, a speaker, an on off switch, a digital display, a Bluetooth connection, a micro-computer chip, a battery, and a warning light but they are combined into one unit. Central control 43 seen as a top view of surface 42 is an integral part of system 30. A combined unit simplifies all reminder functions into one unit.

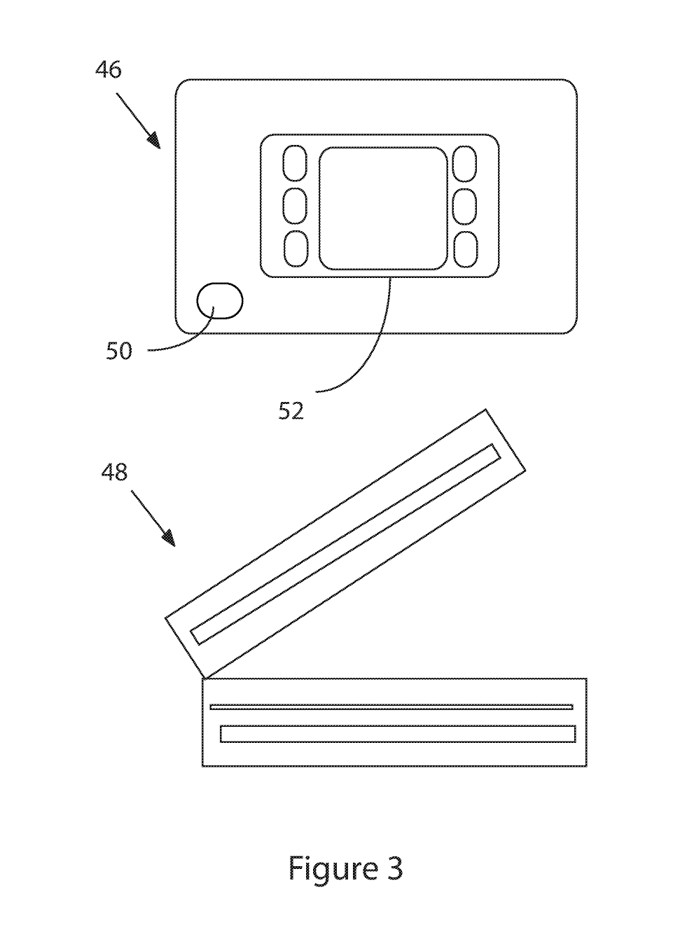

Referring to FIG. 3, remote unit 46 is placed at any remote location to provide reminders to take medication. Remote unit 46 is placed in a pocket, on a counter top, in a car, bed side or the like. Pill scanner 48 is a separate unit to be kept close to the medications. The control center 52 with speaker 50 can be part of remote unit 46 or scanner 48.

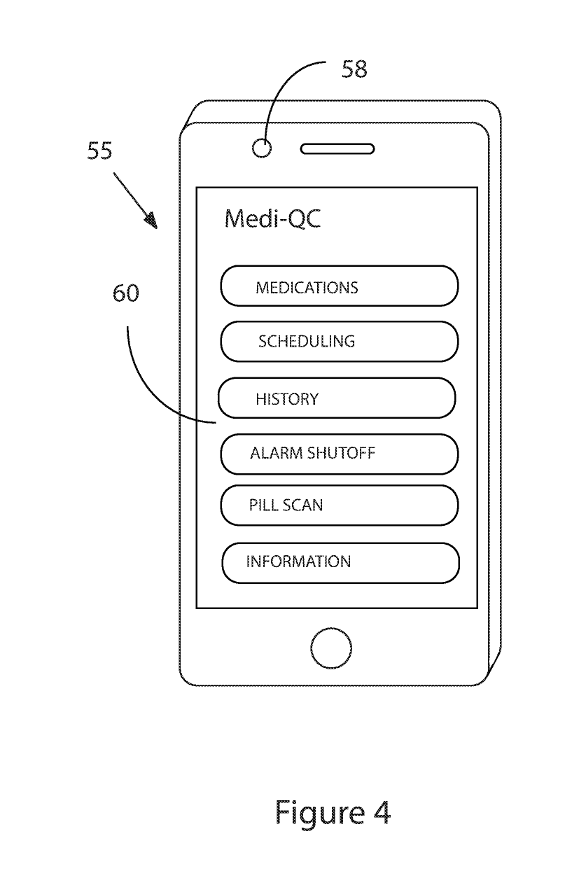

Referring to FIG. 4, cell phone 55 has reminder app 60 and camera 58. The app 60 controls reminder information and functions. Camera 58 produces an image of pills to shut off an alarm including visual, audio, vibration and instruction reminders. The app includes medications, scheduling, history, cloud database, alarm shutoff controls, pill scan, bar code scan, and general information. It also includes secure login for the user, authorized medical personnel and overseers. The app images medication or medication bar code to shut off the reminder. Pill identification is not necessary but preferred with the app.

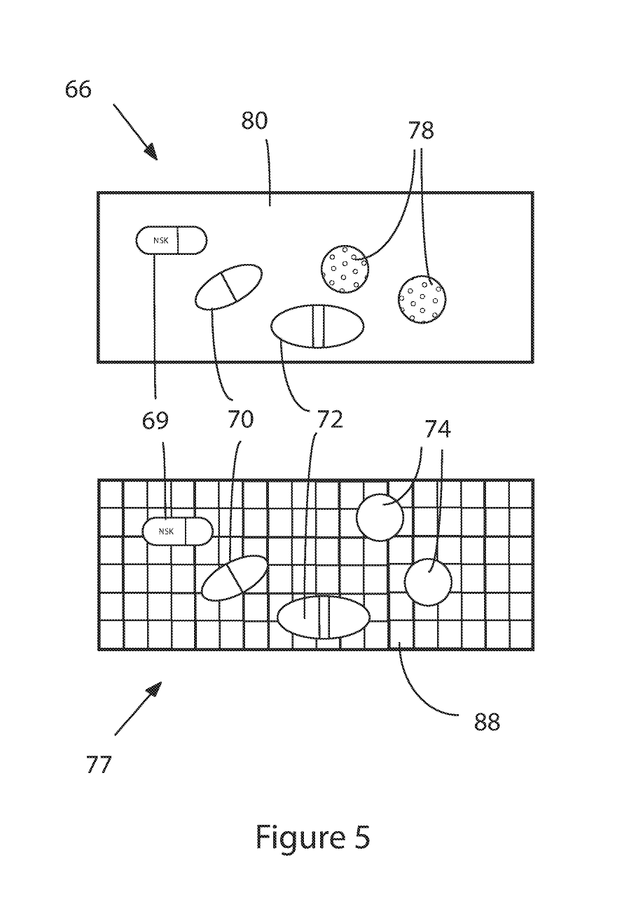

Referring to FIG. 5, pills are places onto a sheet of material referred to as pill scan mat 66 or scan mat 77. Software recognizes the size of pill scan mat 66 which serves as a comparison to determine pill size. Pills are recognized by their type including a tablet, capsule, gel or the like and color. Pills are further recognized by their general shape such as capsule, oval, square, round, triangular, rectangular or the like. Custom shaping with grooves, identifying markings, dimples or the like and surface texture are used for identification as well. Pill 69 is a smooth, blue and green capsule, oval shape, one third of the capsule is smaller, and has identification markings NSK. Pill 70 and 72 are oval shaped tablets. Pill 70 is smaller, more textured, one groove marking, red in color with a length to width ratio of 1.874. Note that identification markings are not required to identify this pill as the pill has been placed upside down such that the markings are on the bottom. The existing information combined with a limited database is enough to identify the pill. Pill 74 and pill 78 are round pills. They appear identical but pill 78 is recognized by different surface texture.

Pill scanning mat 77 has a grid structure imprinted on it. It provides improved size measurement and comparison.

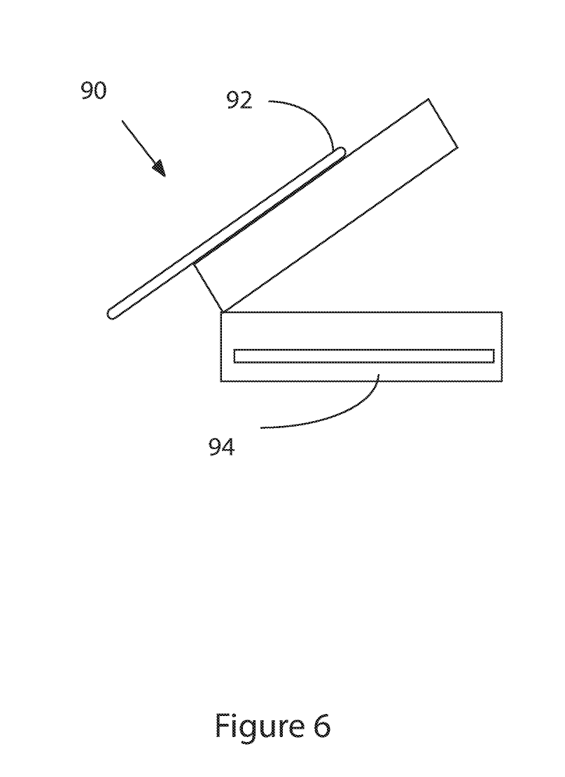

Referring to FIG. 6, an imaging box 90 has lower container 94 to hold pills. The top of imaging box 90 has a hole allowing a cell phone camera to take an image of pills placed in container 94. Cell phone 92 is placed onto the top of imaging box 90. The box is closed and a photograph of the pills is produced. The box provides a fixed position and length to the pills for improved image production and analysis. Computer image recognition is easier and more precise.

1-17. (canceled)

18. A method of capturing images of medications and managing a schedule for a user to take the medications, the method comprising:
capturing, by an imager, images of medication prescribed for a user, wherein the image comprises pill size, type, shape, color, and texture;
defining, by a micro-computer chip, a schedule for the user to consume the medication prescribed;
alerting, by the micro-computer chip, the user to consume the medication based on the schedule;
capturing, by the imager, a new image of the medication when the user is alerted;
comparing, by the micro-computer chip, the new image of the medication with the images of the medication prescribed for the user, wherein the new image is compared using the pill size, shape, color, and texture; and
turning off, by the micro-computer chip, the alert when the new image of the medication matches with the images of the medication prescribed for the user and the schedule defined.

19. The method according to claim 18, wherein the images of medication prescribed and the new image are captured using a reference grid.

20. The method according to claim 18, wherein the user is alerted using one of vibration, visual indication and sound.

21. The method according to claim 18, wherein the user is alerted after a hiatus when the new image does not match with the images of medication prescribed for the user.

22. (canceled)

23. (canceled)

24. (canceled)

25. (canceled)

26. (canceled)

27. The method according to claim 18, further comprising notifying a caregiver if the alert is not turned off within a preset time period.

28-37. (canceled)
